(19) United States
(12) Patent Application Publication
(10) Pub. No.: US 2013/0257747 A1
(43) Pub. Date: Oct. 3, 2013

(54) TOUCH-SENSITIVE PERSONALIZED DISPLAY

(71) Applicants: David P. Rossing, Poway, CA (US); Stephen Martin Ledak, Santee, CA (US); Xiaoqi Zhou, San Diego, CA (US)

(72) Inventors: David P. Rossing, Poway, CA (US); Stephen Martin Ledak, Santee, CA (US); Xiaoqi Zhou, San Diego, CA (US)

(21) Appl. No.: 13/435,395

(22) Filed: Mar. 30, 2012

(51) Int. Cl. G06F 3/041

(52) U.S. Cl. 345/173

(57) ABSTRACT

In one embodiment, a kit for making a touch-sensitive personalized display includes a blank foldable to form a cavity, a print medium including a personalized print medium with a personalization surface to receive a user selected-image, and touch-sensing system is to be at least partially contained within the cavity, the system to detect a mechanical wave in the blank, and to trigger an action at an electronic device responsive to detection of the wave. In another embodiment, a touch-sensitive personalized display includes a blank including extensions folded towards a back surface to form a cavity, a print medium including a personalization surface upon which a user-selected image has been printed via a digital printer, and a touch-sensing system, positioned at least partially within the cavity, to trigger a an action at an electronic device.

### BACKGROUND

Many computers, televisions, audio systems, and other electronic devices have the capability of being controlled by a touch-sensitive remote input unit. Such remote input units allow a user the flexibility to operate the electronic devices from varying locations and with the convenience of touch control.

### BRIEF DESCRIPTION OF THE DRAWINGS

The accompanying drawings illustrate various embodiments and are a part of the specification. The illustrated embodiments are examples and do not limit the scope of the claims. Throughout the drawings, identical reference numbers designate similar, but not necessarily identical elements.

FIG. 1 provides views of a foldable blank with a touch-sensing system, a personalized print medium, and an assembled display according to various embodiments.

FIG. 2 is a back, perspective, exploded view of the assembled display of FIG. 1, according to various embodiments.

FIG. 3 is a cross-section view of the display of FIG. 2, according to various embodiments.

FIG. 4 is a block diagram illustrating a signal processor according to various embodiments.

FIG. 5 provides a front view of an assembled display including a personalized print medium, the medium having a personalization surface with a plurality of command fields and sensors, according to various embodiments.

FIG. 6 provides a rear view of an assembled display including a personalized print medium, the medium having a personalization surface with a plurality of command fields and sensors, according to various embodiments.

FIG. 7 is a back, perspective, exploded view of an assembled display including a folded blank and an inner support member to be secured to the folded blank, according to various embodiments.

FIG. 8 is a cross-section view of the display of FIG. 7, according to various embodiments.

The same part numbers designate the same or similar parts throughout the figures.

### DETAILED DESCRIPTION OF EMBODIMENTS

The touch-sensitive remote input units provided or available to control a computer, television, or other electronic device are typically generic in appearance. For example, the input devices provided by manufacturers to control a television, a DVD player, a stereo receiver, a cable or satellite converter box will frequently closely resemble each other, leading to user confusion. Further user confusion and frustration can arise as a result of the number of such input devices that will be utilized in a typical household. The accumulation of multiple generic-looking input devices can lead to customer dissatisfaction.

Accordingly, various embodiments described herein were developed to provide a touch sensitive input display, and a kit for assembling the touch sensitive input display. The touch-sensitive display in addition to triggering actions in a computer or electronic device, functions as a stand-alone household decoration or as a hanging wall decor. Examples of the disclosure include faux canvas digital prints with appropriate electronic sensors to detect a touch location on the surface, which would then trigger an action, such as a computer playing an audio file. Advantages of the disclosure include that a user can create an inexpensive, personalized artwork that performs the functions of one or more remote control devices, thereby reducing the number of generic remote control devices to be managed, and hidden away when not used. Rather than facing a daunting task of finding and managing of several similar-looking remote control devices, the user can utilize touch controls to manage the device via an electronic control apparatus that is also an aesthetically pleasing or comforting artwork.

As used in this application, a “printer” or “printing device” refers to any liquid inkjet printer, solid toner-based printer, liquid toner-based printer, or any other electronic device that prints.” “Printer” or “printing device” includes any multifunctional electronic device that performs a function such as scanning and/or copying in addition to printing. “Command field” refers to a portion of, or geography within, a personalized print medium that is associated with a command to be sent to an electronic device. Examples of device commands include, but are not limited to “play”, “on”, “off”, “pause”, “louder”, “less loud”, “door up”, “door down”, “select application”, etc.

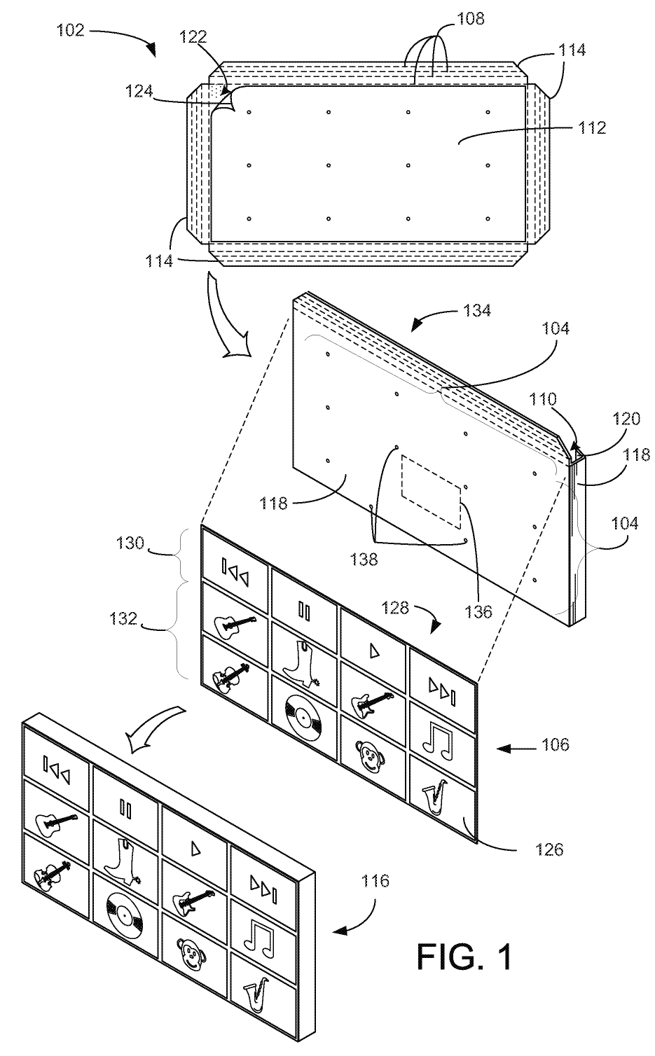

FIG. 1 provides views of a kit to form a touch-sensitive display, and an assembled display, according to various embodiments. The kit of FIG. 1 includes a foldable blank 102, a touch sensing system 104, and a personalizable print medium 106. In an example, the blank 102 may be blank that includes score lines 108 and is foldable according to the score lines 108 to form a cavity 110. In certain embodiments, the folding of the blank 102 is such that the cavity is formed in the shape of a concave. In an example, the blank 102 may be a cellulose product, such as a cellulose card stock, corrugated fiberboard or other paperboard. In other examples, the blank 102 may be made of any lightweight foldable material, including, but not limited to a pure element such as an aluminum foil, a compound of multiple elements such as a copper-zinc alloy foil, a synthetic polymer such a polypropylene, or a composite such as PET/CaCO₃ coextruded sheet.

In the example of FIG. 1, the blank 102 includes a center portion 112 and four extensions 114, with each extension to be folded four times according to the score lines 108 on the extension 114 to form a rectangular polygon display 116. In other examples, the blank is configured to, when folded, form a frame or support for a display that is other than a rectangular polygon (e.g., a triangle, or an oval). In a certain example, each extension may be folded three times upon itself to form a frame or support for the display. In other examples, each extension may in a form to be folded more than four times upon itself. The blank 102 includes a front or adhesion surface 118 and a back surface 120 that is opposite the adhesion surface 118. The adhesion surface 118 is a surface to receive a personalized print medium 106.

In an example, the foldable blank 102 additionally includes an adhesive layer 122 established upon the adhesion surface 118. The adhesive layer 122 may be in the form of a glue, resin, or any other sticky material to promote adhesion of a personalized print medium to the adhesion surface 118 of the blank 102. In an example, the foldable blank 102 also includes a removable liner 124 positioned on the adhesive layer 122. The removable liner 124 is to keep the adhesive layer 122 from sticking to other kit or display materials, or a user, prior to the adhesive layer's intended use to cause adhesion of a personalized print medium 106 to the blank's adhesion surface 118.

Print medium 106 includes a personalization surface 126 to receive a user selected-image, and includes a rear surface 128 opposite the personalization surface 126 to adhere to the blank's adhesion surface 118. The print medium 106 may be in the form of, but is not limited to, a cellulose print medium or a polymeric print medium. In examples, the personalization surface 126 may be a smooth, glossy, shiny surface. In other examples, the personalization surface 126 may be in the form of a satin, matte or other textured surface. In one example, a satin personalization layer includes a matte agent with fillers in the personalization layer, e.g. ground calcium carbonate, clay or organic beads such as polyethylene dispersions. In an example, the matte agent has a large particle size (e.g., from about 20 μm to about 50 μm). In another example, the matte agent is a hollow polymeric particle, wherein from about 20% to 60% of particle volume is occupied by air voids.

Personalization surface 126 is to be personalized with a user-selected image. In examples, the user-selected image is to be printed to the personalization surface using a digital printer. The digital printer used to print the user-selected image may be any type of printing device, including, but not limited to a thermal inkjet printer, a piezoelectric inkjet printer, an electrophotographic printer, or a liquid electrophotographic printer. In the example of FIG. 1, the personalization surface 126 of the print medium 106 is shown with a user-selected image that has been applied to the personalization surface with a digital printer. In this example, the printed personalization image includes printed device control icons 130 (e.g., icons to command a device to “rewind”, “pause”, “play”, “fast forward”, etc.) and music type icons 132 (e.g., icons to select music types such as “acoustic”, “country”, “rock”, “classical”, “oldies”, “children's music”, “jazz”, etc.)

Partially-folded blank 134 illustrates the appearance of foldable blank 102 during a folding operation, prior to adhering of the rear surface 128 of the print medium 106 to the blank's adhesion surface 118. Partially folded-blank 134 Illustrates touch-sensing system 104 to be at least partially contained within the cavity 110. The touch system 104 is a system to detect a mechanical wave in the blank 102, and to trigger an action at an electronic device responsive to detection of the wave. The mechanical wave is a wave caused by a user touching the personalized print medium 106 attached to the blank 102. The user's touch may be a human touch (e.g., pressing a finger) or a touch via a tool (e.g., a stylus) made to the personalization surface 126 of the print medium 106 that is a part of the assembled polygon-shaped display 116. Inclusion, or partial inclusion, of the touch sensing system within the cavity 110 provides considerable advantages, including creating an aesthetically pleasing, attractive display in which the touch sensing system and other electronics are partially hidden or hidden as a user interacts with the display 116. Another advantage of including, or partially including, the touch sensing system within the cavity 110 is protection of the touch sensing system from damage during use or transport of the display 116.

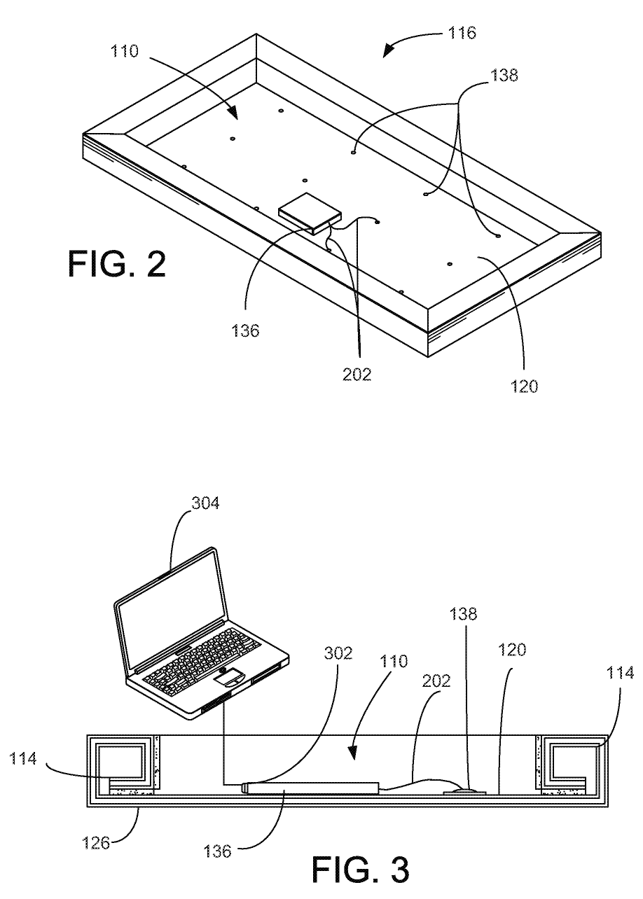

FIG. 2 is a back, perspective, exploded view of the assembled display of FIG. 1, according to various embodiments. FIG. 3 is a cross-section view of the assembled display of FIGS. 1 and 2, according to various embodiments. For sake of clarity, FIG. 3 illustrates one sensor 138 rather than the full set of sensors shown in FIGS. 1 and 2. Notwithstanding the illustration of one sensor, the example of FIG. 3 should be viewed as illustrating the plurality of sensors 138 electronically attachable or attached to the signal processor 136 via leads 202 as shown in FIG. 2. In the example of FIGS. 1-3, the touch-sensing system 104 includes a signal processor 136, and a plurality of sensors 138 that are attachable to the back surface 120 of the blank 102 and are electronically connectable to the signal processor 136. The sensors 138 are to detect the mechanical wave in the blank that is caused when a user touches a field within the print medium 106, and to communicate an electronic signal descriptive of the wave to the signal processor 136. In an example, the sensors 138 include piezo sensors. In another example, the sensors 138 include accelerometer sensors. In an example, the signal is an analog signal that communicates information descriptive of the wave via varying current or voltage along a circuit that includes the sensors 138, the signal processor 136, and cable or wire leads 202 that electronically connect the sensors 138 and the signal processor 136. For sake of clarity, in FIG. 2 two sensors 138 are shown connected by leads to the signal processor 136. In an example, each of the sensors 138 is connected via a cable or wire lead to the signal processor 136. In another example, each of the sensors 138 is connected to the signal processor 136 via a separate lead, or a separate set of leads.

In an example, the kit's sensors 138 are attached to the back surface 120 of the blank 102. In another example, the kit's sensors 138 are to be attached to the back surface 120 by a user that is assembling the kit. In an example, the sensors 138 that are attached to the back surface 120 of the blank 102 are positioned within the cavity 110 when the display 116 is fully assembled. In an example, the sensors 138 that are attached to the back surface 120 of the blank 102 by a user are positioned within the cavity 110 when the display 116 is fully assembled. In an example kit, the sensors are electronically connected to the signal processor 136 by leads 202. In another example kit, the sensors 138 are unconnected, and are to be electronically connected, e.g., via cable or wire leads, to the signal processor 136 by a user that is assembling the display.

The signal processor 136 is to receive the signal from one or more of the sensors 138, to identify a command associated with the signal to trigger an action at an electronic device 304, and to send the identified command to the device 304. In an example, the signal processor 136 identifies the first command by associating the first command with the first signal via a database. In an example, a kit includes a single signal processor 136 to be included within the display (e.g., attached to the back surface 120 of the blank 102 or attached to a support material or support member that is attached to the back surface 120 of the blank). In another example, the assembled display 116 may include multiple signal processors 136.

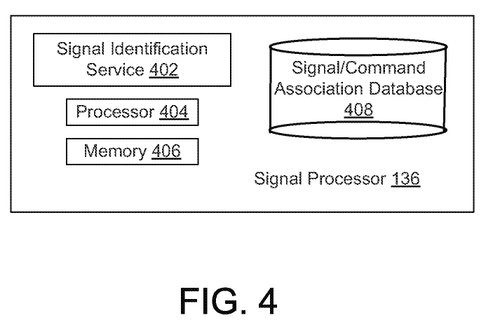

FIG. 4 is a block diagram illustrating a signal processor according to various embodiments. In the example of FIG. 4, the signal processor 136 includes a signal identification service 402, a processor 404, a memory 406, and a signal/command association database 408. Signal identification service 402 represents generally any combination of hardware and programming configured to associate signals received from one more sensors 138 with commands to trigger actions at an electronic device 304. Signal identification service 402 receives the signal from one or more of the sensors 138, accesses signal/command association database 408 to identify a command associated with the signal to trigger an action at an electronic device 304, and sends the identified command to the device 304. Examples of such commands include, but are not limited to, commands to start, pause or stop, the electronic device, commands to select content available via the device, and/or commands to select device, volume, brightness, or speed, etc. Signal/command association database 408 represents generally a database, registry, lookup table or list that associates sensor signals and commands trigger actions at an electronic device. Processor 404 represents generally any instruction execution system, such as a computer/processor based system or an ASIC (Application Specific Integrated Circuit), a computer, or other system that can fetch or obtain instructions or logic stored in memory 406 and execute the instructions or logic contained therein. Memory 406 represents generally any memory configured to store program instructions and other data.

Returning to FIG. 3, the kit and display 116 include an interface 302 to connect the signal processor 136 with the electronic device 304. In examples, the interface 302 may be any type of interface or connector or adapter to connect electronic devices, components, or apparatuses, including, but not limited to, a cable, cable connectors, interface card, card slot and/or port. In another example, the interface 302 includes a wireless transmitter such that the signal processor 136 can, after making an association of a sensor signal with a command to trigger an at an electronic device 304 via the database 408, wirelessly send the command to the electronic device 304.

In an example, the electronic device 304 to be controlled via user touch is a device that is not included within the kit, but which is attachable to the signal processor 136 via the interface 302 included within the kit. In the example of FIG. 3, the electronic device 304 to be controlled via the assembled display 116 may be a notebook computer. In other examples, the electronic device 304 to be controlled via the assembled display 116 may be a tablet computer, television, smartphone, MP3 player, stereo receiver, lighting apparatus, electronic door opening apparatus, or any other electronic device.

In another example, the electronic device 304 to receive the command, and thus be controlled by a user touch upon the personalization surface 126 of the display 116, is an electronic device that is included within the kit. For instance, the electronic device 304 may be an audio device to be included with the cavity 110 of the finished display 116, the audio device to cause an audio transmission of songs, speech, or other recorded content that is held in memory within the audio device. In another example, the electronic device 304 may be a radio receiver to be located within the cavity 110 of the finished display 116, the radio receiver to play audio content that is received at the receiver via electromagnetic waves. In another example, the electronic device 304 may be a digital clock that is a part of the kit and to be attached to the personalization surface 126 of the finished display 116.

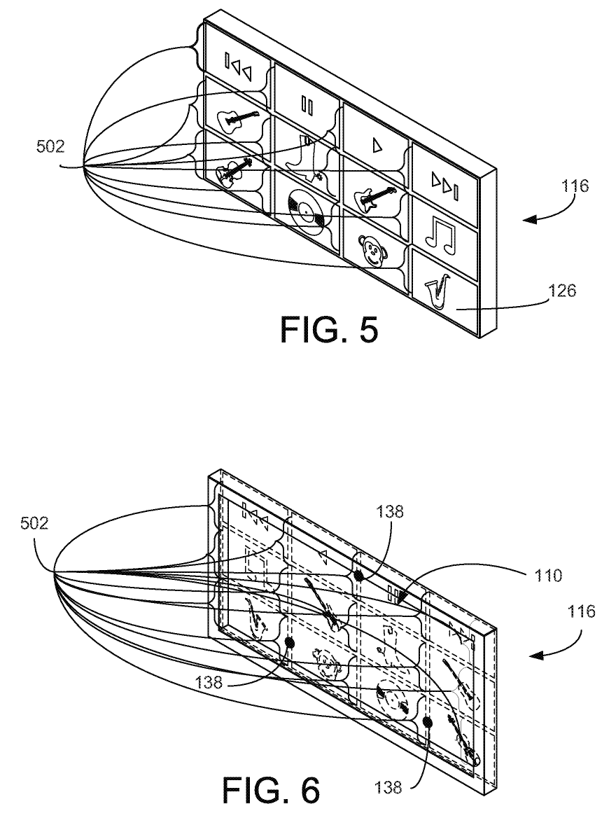

FIG. 5 provides a front view of the assembled display 116 of FIGS. 1-4 after folding of the blank extensions 114 (FIG. 1), adhering of the extensions 114, adhering of the personalization surface 126 to the blank 102. The display 116 includes a print medium 106, the medium having a personalization surface attached to the blank's adhesion surface 118 (FIG. 1), and having a touch-sensing system 104 attached to the blank's back surface 120. In the example of FIG. 5, the touch-sensing system 104 (FIG. 1) includes a plurality of sensors 138 (FIGS. 1-3), and the personalization surface 126 includes a plurality of command fields 502 with each field having an associated sensor to detect a mechanical wave indicating a touch within that field. The sensors are attached to the back surface of the assembled display 116 and are not visible in FIG. 5. In this example, there are twelve sensors, with each sensor uniquely associated with one of the twelve command fields 502 designated by the device control icons 130 and the music type icons 132 that are printed on the personalization surface 126 of the display 116. In other embodiments, depending upon the type of electronic device to be controlled by the display 116, the icon selection and command field 502 layout upon the personalization surface 126 will differ from the examples illustrated in FIGS. 1, 5, and 6.

FIG. 6 provides a rear view of another example of an assembled display 116 according to embodiments of the disclosure. The display 116 includes a personalized print medium 106 (FIG. 1). The personalization was applied via a digital printer to the medium's personalization surface 126 (FIG. 1), and includes a plurality of command fields 502 designated by device control icons 130 (FIG. 1) and music type icons 132 (FIG. 1) printed upon the personalization surface 126. The display 116 includes a touch-sensing system 104 (FIG. 1) with a signal processor 136 (FIGS. 1-3) and three sensors 138. The signal processor 136 is to associate a mechanical wave with a touch on the personalization surface 126 of the print medium 106 within a command field 502 based upon readings from each of the three sensors 138. In an example, the association of the mechanical waves to a user touch in a command field 5-2 may include the signal processor 136 triangulating a location of the touch upon the personalization surface 126 utilizing signals received from the three sensors 138. In other embodiments, more or less than three sensors may be included in the kit and utilized to provide signals regarding a user touch. In embodiments, the number of sensors is a number that is at least three, but is less than number of command fields designated by, or included within, the personalization surface 126.

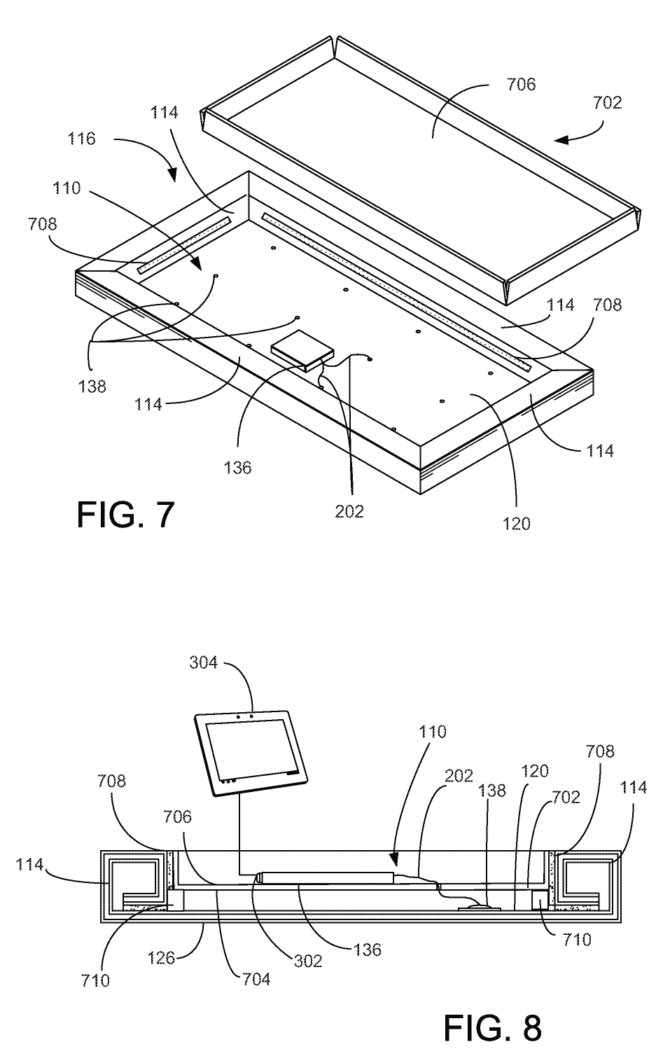

In other embodiments, the kit of FIGS. 1-4 may also include a support material or support member 702, for insertion into the display 116 adjacent to the back surface 120 of the blank, and within the cavity 110 to provide structural and/or aesthetic advantages for the display 116. FIGS. 7 and 8 illustrate examples of such embodiments. FIG. 7 is a back, perspective, exploded view of an assembled display 116 that includes a folded blank 102 and an inner support material 702 to be secured to the folded blank 102, according to various embodiments. FIG. 8 is a cross-section view of the display 116 of FIG. 7, according to various embodiments. In the example of FIGS. 7 and 8, the support member 702 is attachable to the display 116 via a sticky tape, glue, or other adhesive 708 that is a part or attached to one or more of the extensions 114. In another example, the support member 702 is attachable to the display 116 via a sticky tape, glue, or other adhesive 708 that is attached to or part of the support member 702. In another example, the support member may be positioned in the display 116 via abutment or attachment to a spacer 710 or other structural element that abuts or is attached to the back surface 120 of the folded blank 102. The spacer 710, when utilized, is to create space for the sensors 138 as between the back surface 120 and the support member 702. In some embodiments, the spacer 710 is also to create space for the signal processor 136 as between the back surface 120 and the support member 702

The signal processor 136 is attachable to the support member 702. In an example, the support member 702 insert may make the display 116 more sturdy and or allow for a larger display than would be possible without the insert. In another example, the support member 702 insert may make for a more attractive display 116 by covering or partially covering the sensors. In another example, the support member 702 insert may make for a more attractive display 116 by covering or partially covering the signal processor 136. In an example, the signal processor 136 is attachable to a first side 704 of the insert 702 that faces the back surface 120, i.e. is inward-facing when the display 116 is assembled. In another example, the signal processor 136 is attachable to a second side 706 of the insert 702 that is outward-facing when the display 116 is assembled. In this latter embodiment, it may be necessary to create a hole in the insert 702 to allow the leads 202 to pass through the insert 702 and connect the sensors 138 to the signal processor 136.

Various modifications may be made to the disclosed embodiments and implementations without departing from their scope. Therefore, the illustrations and examples herein should be construed in an illustrative, and not a restrictive, sense.

What is claimed is:

1. A kit for making a touch-sensitive personalized display, comprising:
a blank that is foldable according to score lines to form a cavity, the blank including
an adhesion surface to receive a personalized print medium, and
a back surface opposite the adhesion surface;
the print medium including a personalization surface to receive a user selected-image, and including a rear surface opposite the personalization surface to adhere to the blank's adhesion surface; and
a touch-sensing system to be at least partially contained within the cavity, to detect a mechanical wave in the blank, and to trigger an action at an electronic device responsive to detection of the wave.

2. The kit of claim 1, wherein the blank includes a center portion having at least three extensions, and each extension is to be folded at least three times according to the score lines on the extension.

3. The kit of claim 1, wherein the user-selected image is to be printed to the personalization surface using a digital printer chosen from a thermal inkjet printer, a piezoelectric inkjet printer, an electrophotographic printer, and a liquid electrophotographic printer.

4. The kit of claim 1, wherein the blank is to be folded into the form of a polygon.

5. The kit of claim 1, wherein the blank includes:
an adhesive layer established upon the adhesion surface; and
a removable liner positioned on the adhesive layer.

6. The kit of claim 1, wherein the touch-sensing system includes
a sensor, attachable to the back surface of the blank and electronically connectable to a signal processor, to detect the wave and communicate an electronic signal descriptive of the wave to the signal processor;
the signal processor, to receive the signal, to identify a command associated with the signal to trigger the action, and to send the command to the device; and
an interface to connect the signal processor with the electronic device.

7. The kit of claim 6, wherein the sensor is chosen from a piezo sensor and an accelerometer sensor.

8. The kit of claim 6, wherein the signal is an analog signal.

9. The kit of claim 6, wherein the sensor is positioned within the cavity.

10. The kit of claim 6, wherein the sensor is attached to the back surface.

11. The kit of claim 6, wherein the sensor is connected to the signal processor.

12. The kit of claim 6,
wherein the signal is a first signal and the command is a first command;
further comprising a database associating signals with commands to trigger actions at the electronic device; and
wherein the signal processor identifies the first command by associating the first command with the first signal via the database.

13. The kit of claim 6,
wherein the touch-sensing system includes a plurality of sensors; and
wherein the personalization surface is to include a plurality of command fields with each field having an associated sensor to detect a mechanical wave indicating a touch within that field.

14. The kit of claim 6,
wherein the personalization surface is to include a first plurality of command fields;
wherein the touch-sensing system includes a second plurality of sensors that numbers at least three but is less than number of fields; and
wherein the signal processor is to associate a mechanical wave with a touch on the print medium within a field based upon readings from each of the plurality of sensors.

15. The kit of claim 1, further comprising a support member, for insertion into the display adjacent to the back surface and within the cavity, and wherein the signal processor is attachable to the support member.

16. A touch-sensitive personalized display, comprising:
a blank including
a front surface and an opposed back surface and at least three sides, and
an extension for each of the sides, with each extension folded towards the back surface at least three times according to score lines to form a cavity;
a print medium adhered to the front surface, the medium including a personalization surface upon which a user-selected image has been printed via a digital printer, and including a rear surface opposite the personalization surface adhered to the blank's back surface; and
a touch-sensing system, positioned at least partially within the cavity, to trigger a an action at an electronic device.

17. The display of claim 16, wherein the touch-sensing system includes:
a sensor, attached to the back surface of the blank and electronically connectable to a signal processor, to detect the wave and communicate an electronic signal descriptive of the wave to the signal processor;
the signal processor, to receive the signal, to identify a device command associated with the signal, and to send the device command to the device; and
an interface to connect the signal processor with the electronic device.

18. The display of claim 17, wherein the personalization surface designates a plurality of command fields, with each field having an associated sensor to detect a touch within that field.

19. The display of claim 17, wherein the personalization surface designates a plurality of command fields, wherein the touch-sensing system includes a plurality of sensors that numbers at least three but is less than number of command fields, and wherein the signal processor is to associate a mechanical wave with a touch on the print medium within a field based upon readings from each of the sensors.

20. A kit for making a touch-sensitive personalized display to function as user interface, comprising:
a blank that is foldable to form a polygon with a cavity, the blank including
an adhesion surface to receive a personalized print medium;
a back surface opposite the adhesion surface;
a center portion having at least three extensions, with each extension to be folded at least three times according to score lines on the extension;
an adhesive layer established upon the adhesion surface;
a removable liner positioned on the adhesive layer;
the print medium including a personalization surface to receive a user selected-image via a digital printer and including a rear surface opposite the personalization surface to adhere to the blank's adhesion surface; and
a touch-sensing system at least partially contained within the cavity, the system to detect a mechanical wave in the blank and trigger an action at an electronic device responsive to detection of the wave, the system including
a piezo sensor, attachable to the back surface of the blank and electronically connectable to a signal processor, to detect the wave and communicate a first electronic signal descriptive of the wave to the signal processor;
a database associating electronic signals with commands to trigger actions at the electronic device;
the signal processor, to receive the first signal, to identify a first command associated with the first signal via the database, and to send the first command to the device; and
an interface to connect the signal processor with the electronic device.
